(19) United States
(12) Patent Application Publication
(10) Pub. No.: US 2006/0170531 A1
(43) Pub. Date: Aug. 3, 2006

(54) Next generation vehicle keys

(75) Inventors: Chandrasekhar Narayanaswami, Wilton, CT (US); Mandayam Thondanur Raghunath, Fishkill, NJ (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 11/049,562

(22) Filed: Feb. 2, 2005

(51) Int. Cl. H04Q 1/00; G05B 19/00

(52) U.S. Cl. 340/5.53; 340/5.72

(57) ABSTRACT

The invention broadly and generally provides a key for a vehicle comprising: (a) a biometric sensor operable to create a measurement of at least one biometric property; (b) a data storage device operable to store data; (c) an authenticator operable to detect existence of a specified relationship between the aforesaid measurement and data stored within the aforesaid data storage device; and (d) a communication device operable to communicate in response to the aforesaid existence of the aforesaid specified relationship.

### FIELD OF THE INVENTION

The present invention relates to a novel key for vehicles.

### BACKGROUND OF THE INVENTION

BMW (of Munich, Germany) manufactures automotive keys which can store a limited amount of data that is transferred to the key from the BMW automobile. The stored data, which includes mileage information and the vehicle identification number, is used by the BMW service personnel and is not generally made available to owners or operators of the vehicle. In the context of the present invention, it shall be understood that “vehicle” includes automobiles, motorcycles, trucks, boats, airplanes, trains, and the like.

### SUMMARY OF THE INVENTION

The invention broadly and generally provides a key for a vehicle comprising: (a) a biometric sensor operable to create a measurement of at least one biometric property; (b) a data storage device operable to store data; (c) an authenticator operable to detect existence of a specified relationship between the aforesaid measurement and data stored within the aforesaid data storage device; and (d) a communication device operable to communicate in response to the aforesaid existence of the aforesaid specified relationship. In some embodiments, the aforesaid authenticator comprises a microprocessor.

According to a preferred embodiment, the aforesaid key is operable to enable operation of said vehicle upon communication by the aforesaid communication device of the aforesaid existence of the aforesaid specified relationship.

According to a preferred embodiment, the aforesaid communication device comprises an electrical connector, preferably a universal serial bus connector.

According to a preferred embodiment, the aforesaid communication device is operable only when a selected specified relationship exists.

According to a preferred embodiment, the aforesaid key comprises a notification device which is operable to provide an indication of a state of the aforesaid key or the aforesaid vehicle. Preferably, the aforesaid notification would depend upon the aforesaid existence of the aforesaid specified relationship.

According to a preferred embodiment, the aforesaid communication device is operable to transfer data between the aforesaid data storage device and a computer.

According to a preferred embodiment, the aforesaid communication device is operable to transfer data between the aforesaid data storage device and the aforesaid vehicle.

According to a preferred embodiment, the aforesaid key comprises a GPS device operable to produce location data and transfer the aforesaid location data to the aforesaid data storage device.

According to a preferred embodiment, the aforesaid data storage device comprising music files.

According to a preferred embodiment, the aforesaid key further comprises an energy data storage device operable to energize the aforesaid authenticator.

According to a preferred embodiment, the aforesaid data storage device contains settings to be applied to the aforesaid vehicle. Preferably, the aforesaid personal computer is operable to receive data for the aforesaid vehicle from a network.

According to a preferred embodiment, the aforesaid biometric property comprises a measure of concentration of ethyl alcohol.

According to a preferred embodiment, the aforesaid biometric property comprises a pattern of a fingerprint.

The present invention further broadly and generally provides a vehicle key system comprising: (a) a vehicle; and (b) a key for the aforesaid vehicle, the aforesaid key comprising: (i) a biometric sensor operable to create a measurement of at least one biometric property; (ii) a data storage device operable to store data; (iii) an authenticator operable to detect existence of a specified relationship between the aforesaid measurement and data stored within the aforesaid data storage device; and (iv) a communication device operable to communicate in response to the aforesaid existence of the aforesaid specified relationship.

According to a preferred embodiment, the vehicle key system further comprises a computer operable to communicate with the aforesaid communication device.

According to a preferred embodiment, the aforesaid vehicle comprises a GPS receiver operable to produce location data and transfer the aforesaid location data to the aforesaid data storage device.

### BRIEF DESCRIPTION OF THE DRAWINGS

FIG. 1 is a schematic representation of a vehicle key in accordance with the present invention.

FIG. 2 is a schematic drawing of the electronic fob circuitry and functional components of FIG. 1.

FIG. 3 is a schematic drawing of a vehicle equipped with a computer for communication with the vehicle key of FIG. 1.

### DETAILED DESCRIPTION OF PREFERRED EMBODIMENT

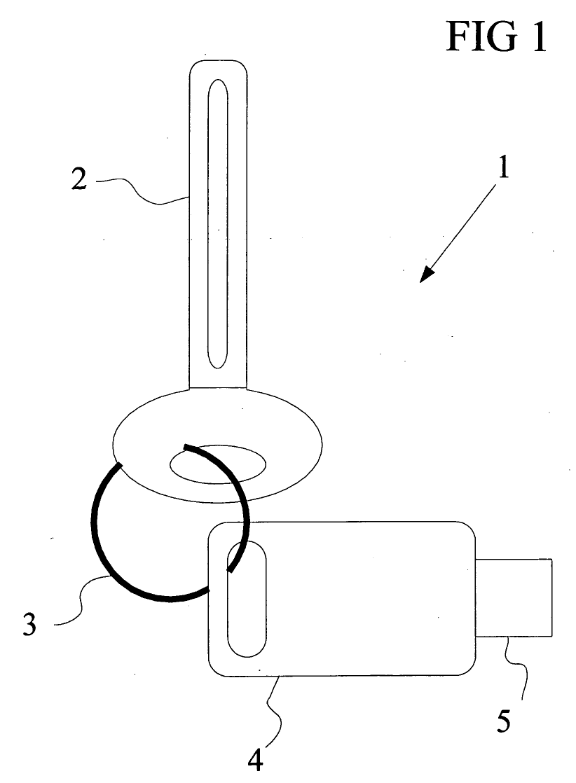

FIG. 1 shows a vehicle key 1 in accordance with the the present invention. The key embodiment shown in FIG. 1 1 takes the form of a mechanical key 2 attached to a key fob 4 by a key ring 3. A universal serial bus (USB) connector 5 is on the end of the key fob 4, permitting the key 1 to communicate with USB-equipped computers.

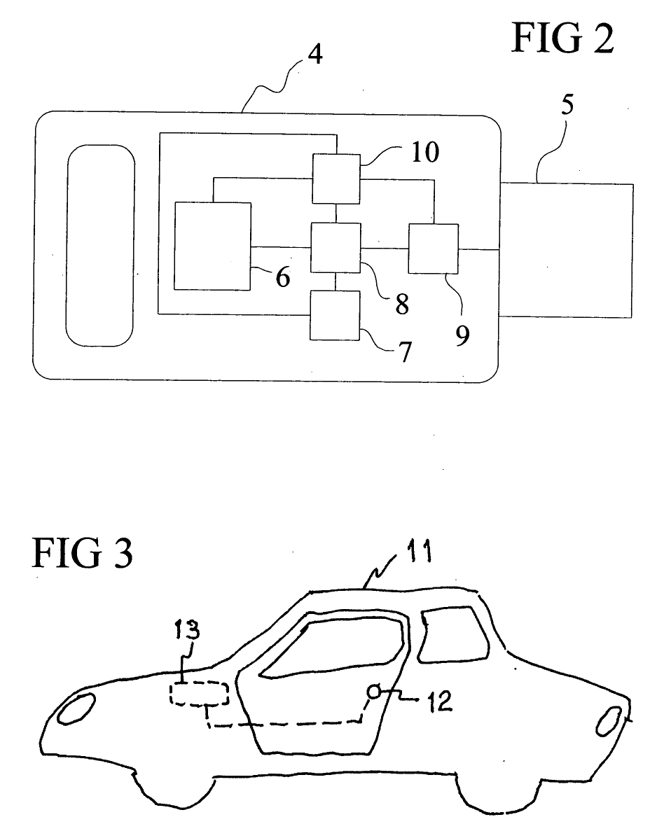

FIG. 2 is a schematic drawing of the electronic fob circuitry and functional components of FIG. 1. In the embodiment shown in FIG. 2, The fob contains a biometric sensor 6 which is connected to an authenticator 8 which comprises a microprocessor. The biometric sensor 6 can measure any number of properties including the concentration of ethyl alcohol, the pattern of a fingerprint, another biometric property, or some combination thereof. Fingerprint scanners are currently available from Veridicom, Inc. (1248 Reamwood Ave, Sunnyvale, Calif. 94089). A data storage device 7 is also connected to the authenticator. The authenticator 8 uses the communication device 9 to communicate the existence of a specified relationship between a measurement created by the biometric sensor 6 and data stored within the data storage device 7. For example, the authenticator 8 could be programmed to report the existence of a relationship (in this case, a statistical match) between a user fingerprint and fingerprint data stored on the data storage device 7. Upon finding such a match, the authenticator would send a message indicating a match through the communication device 9. Alternatively, the authenticator 8 could permit data to transfer between the communication device 9 and the data storage device 7 upon finding a match type relationship. An energy storage device 10 such as a battery, provides power for the biometric sensor 6, the authenticator 8, the data storage device 7, and the communication device 9.

FIG. 3 is a schematic drawing of a vehicle equipped with a computer for communication with the vehicle key of FIG. 1. The vehicle shown is a car 11 having a door-mounted lock 11 connected to a computer 13. The biometric sensor 6 can be used to create a measurement that will be used by the authenticator 8 to confirm the identity of the car owner. Once this authentication has occurred, the key 4 will send a message to the vehicle lock and the vehicle operator will be permitted to enter and activate the vehicle.

While changes and variations to the embodiments may be made by those skilled in the field of authentication devices, the scope of the invention is to be determined by the appended claims.

What is claimed is:

1. A key for a vehicle comprising:
(a) a biometric sensor operable to create a measurement of at least one biometric property;
(b) a data storage device operable to store data;
(c) an authenticator operable to detect existence of a specified relationship between said measurement and data stored within said data storage device; and
(d) a communication device operable to communicate in response to said existence of said specified relationship.

2. A key as set forth in claim 1, wherein said authenticator comprises a microprocessor.

3. A key as set forth in claim 1, said key being operable to enable operation of said vehicle upon communication by said communication device of said existence of said specified relationship.

4. A key as set forth in claim 1, wherein said communication device comprises an electrical connector.

5. A key as set for th in claim 4, said electrical connector comprises a USB connector.

6. A key as set forth in claim 1, further comprising a display operable to indicate the remaining storage on said data storage device.

7. A key as set forth in claim 1, further comprising a notification device operable to provide an indication of a state of said key or said vehicle upon enablement of said notification device upon said existence of said specified relationship.

8. A key as set forth in claim 1, wherein said communication device is operable only when a selected specified relationship exists.

9. A key as set forth in claim 1, wherein said communication device being operable to transfer data between said data storage device and a computer.

10. A key as set forth in claim 1, wherein said communication device is operable to transfer data between said data storage device and said vehicle.

11. A key as set forth in claim 10, wherein said key comprises a GPS device operable to produce location data and transfer said location data to said data storage device.

12. A key as set forth in claim 10, said data storage device comprising music files.

13. A key as set forth in claim 1, further comprising an energy storage device operable to energize said authenticator.

14. A key as set forth in claim 1, wherein said data storage device contains settings to be applied to said vehicle.

15. A key as set forth in claim 14, wherein said PC is operable to receive data for said vehicle from a network.

16. A key as set forth in claim 1, said biometric property comprising a measure of concentration of ethyl alcohol.

17. A key as set forth in claim 1, said biometric property comprising a pattern of a fingerprint.

18. A vehicle key system comprising:
(a) a vehicle; and
(b) a key for said vehicle, said key comprising: (i) a biometric sensor operable to create a measurement of at least one biometric property; (ii) a data storage device operable to store data; (iii) an authenticator operable to detect existence of a specified relationship between said measurement and data stored within said data storage device; and (iv) a communication device operable to communicate in response to said existence of said specified relationship.

19. A vehicle key system as set forth in claim 18, further comprising a computer operable to communicate with said communication device.

20. A vehicle key system as set forth in claim 18, said vehicle comprising a GPS receiver operable to produce location data and transfer said location data to said data storage device.
